(19) United States
(12) Patent Application Publication
(10) Pub. No.: US 2025/0104171 A1
(43) Pub. Date: Mar. 27, 2025

(54) DATA INTERCHANGE SYSTEM

(71) Applicant: Black Hills IP Holdings, LLC, Minneapolis, MN (US)

(72) Inventors: Steven W. Lundberg, Edina, MN (US); Elliott M. Higgins, Vandnais Heights, MN (US)

(21) Appl. No.: 18/892,016

(22) Filed: Sep. 20, 2024

Related U.S. Application Data
(60) Provisional application No. 63/540,027, filed on Sep. 22, 2023.

(51) Int. Cl. G06Q 50/18; G06Q 10/10

(52) U.S. Cl. CPC G06Q 50/184; G06Q 10/103

(57) ABSTRACT

Various embodiments disclosed relate to a data interchange system for collaboration between multiple entities. The present disclosure includes a method of aggregating information in a data interchange system to be accessed by an entity, the data interchange system for use with a calendaring system for matters having due dates, wherein the method comprises: identifying a matter to be updated by filtering a plurality of matters, the matter associated with at least one entity matter dataset; a first entity corresponding with a first entity matter dataset; the first entity granting a second, third, or more entity a privilege to access a second, third, or more entity matter dataset, the second, third, or more entity matter dataset corresponding with the second, third, or more entity; receiving an indication of a document having a due date and attributes, the document being sourced by the second, third, or more entity, and designated by a source category; transforming the document and the attributes of the document according to preferences as indicated by the second, third, or more entity to create a transformed transaction, the transformed transaction comprising the document, source category, and document attributes; logging the transformed transaction in the first, second, third, or more datasets, the second, third, or more datasets containing documents from the first entity matter dataset transformed according to the preferences of the second, third, or more entity; and communicating the transformed transaction to parties as indicated by a second, third, or more entity with communicating privileges.

### CLAIM OF PRIORITY

This application claims the benefit of priority under 35 U.S.C. § 119 (e) to U.S. Patent Application Ser. No. 63/540,027, filed on Sep. 22, 2023, which is incorporated by reference herein in its entirety.

### TECHNICAL FIELD

Embodiments described herein generally relate to an electronic docketing system, and more specifically, to an electronic docketing system that provides synchronized matter datasets for multiple entities which contain documents or reports that are transformable according to the preferences of an entity.

### BACKGROUND

Companies often file for and hold a variety of intellectual property rights, such as copyrights, trademarks, and patents, depending on their business purpose and goals. Often, such intellectual property matters require coordination with different law firms or attorneys working in foreign jurisdictions. This coordination requires synchronized data sharing and transfer with individualized formatting.

### SUMMARY OF THE DISCLOSURE

Discussed herein is a method to improve accessibility and organization of docketing matters. The method automates the process of locating, formatting, storing, and transferring documents relating to legal matters which must be accessed by various entities working in collaboration. The data interchange system is a common intermediary which entities interact with to accomplish various tasks relating to a particular matter.

The data interchange system synchronizes datasets owned by multiple entities who are collaborating on a particular matter. Information added to a matter dataset owned by one entity may be automatically copied to a matter dataset owned by a second entity and transformed according to the preferences of that entity.

The level of accessibility to a matter dataset located within the data interchange system varies based on the privileges granted. By controlling access, the data is secured from those without privileges and easily accessible to those with privileges.

Problems with the conventional intellectual property data interchanges include a presence of unknown variations between international patent offices, inefficient information transfer, and errors in docketing. With conventional intellectual property data interchanges, data from patent offices of a certain country may be difficult to find and are communicated solely through email correspondence.

In addition, data may need to be transformed prior to being stored in a matter dataset, such as through translation, updating of application numbers, formatting changes, or adjusting filing dates, for example. These transformations may add time and cost to the process of storing information.

When multiple entities are collaborating on a matter, it is difficult and tedious to ensure that each entity owns or has access to all necessary documents or reports. Often, an entity may have missing information or may not be notified about the issuance of a document or report. Foreign entities may also have added complexities like the need for translation, formatting changes, or filing date adjustments.

Matter datasets including information and document history may also need to be transferred to new firms. The current process of doing so is tedious, time consuming, and may result in errors. Because the process is not automated and data is coming from various sources, the result may be inconsistent and may result in inaccurate data.

The systems and techniques discussed herein reduce data errors by automating the process and creating a central location by which information is distributed improving accessibility for documents that are normally difficult to access or transfer. Time delay and errors may also be decreased when coordinating matter datasets with another entity. These improvements enable users of the data interchange system to have greater confidence in their data and their ability to seamlessly transfer matter datasets.

Creating synchronized matter datasets increases confidence that necessary information is available to interested entities and is in the appropriate format for a particular entity. The improved data interchange system discussed herein streamlines collaboration by ensuring that information for entities is not missing from the dataset. The improved data interchange system automates the time-consuming process of formatting information contained in a matter dataset according to preferences of a particular entity.

Access to the data interchange system is controlled through a system of privileges to improve security. Controlled data access allows for flexibility during collaboration by, for example, allowing certain entities the privilege of viewing matter datasets but not the privilege of ownership.

Automating the transfer of matter datasets to new entities to reduce inefficiency and inaccurate data transfer. This is accomplished by granting access to a matter dataset when an entity is given ownership privileges and by automatically granting access to the full matter dataset at the time of transfer.

In an example, a method of aggregating information in a data interchange system to be accessed by an entity, the data interchange system for use with a calendaring system for matters having due dates, comprises: identifying a matter to be updated by filtering a plurality of matters, the matter associated with at least one entity matter dataset; a first entity corresponding with a first entity matter dataset; the first entity granting a second, third, or more entity a privilege to access a second, third, or more entity matter dataset, the second, third, or more entity matter dataset corresponding with the second, third, or more entity; receiving an indication of a document having a due date and attributes, the document being sourced by the second, third, or more entity, and designated by a source category; transforming the document and the attributes of the document according to preferences as indicated by the second, third, or more entity to create a transformed transaction, the transformed transaction comprising the document, source category, and document attributes; logging the transformed transaction in the first, second, third, or more datasets, the second, third, or more datasets containing documents from the first entity matter dataset transformed according to the preferences of the second, third, or more entity; and communicating the transformed transaction to parties as indicated by a second, third, or more entity with communicating privileges.

In an example, at least one non-transitory machine-readable medium comprises instructions that, when executed by at least one processor implements a method of aggregating information in a data interchange system to be accessed by an entity, the data interchange system for use with a calendaring system for matters having due dates, the method comprising: identifying a matter to be updated by filtering a plurality of matters, the matter associated with at least one entity matter dataset; a first entity corresponding with a first entity matter dataset; the first entity granting a second, third, or more entity a privilege to access a second, third, or more entity matter dataset, the second, third, or more entity matter dataset corresponding with the second, third, or more entity; receiving an indication of a document having a due date and attributes, the document being sourced by the second, third, or more entity, and designated by a source category; transforming the document and the attributes of the document according to preferences as indicated by the second, third, or more entity to create a transformed transaction, the transformed transaction comprising the document, source category, and document attributes; logging the transformed transaction in the first, second, third, or more datasets, the second, third, or more datasets containing documents from the first entity matter dataset transformed according to the preferences of the second, third, or more entity; and communicating the transformed transaction to parties as indicated by a second, third, or more entity with communicating privileges.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an automated docketing system in an example.

FIG. 2 is schematic diagram of sources of data used in an intellectual property data interchange system in an example.

FIG. 3 is a flow chart depicting a general process of creating synchronized matter datasets for multiple entities.

FIG. 4 is a flow chart depicting a process of granting privileges for the data interchange system to multiple entities.

FIG. 5 is a flow chart depicting the process of distributing information through the data interchange system.

FIG. 6 depicts a schematic of a user interface for use with the data interchange system in an example.

FIG. 7 depicts a schematic of a user interface for use with the data interchange system in an example.

FIG. 8 depicts a schematic of a user interface for use with the data interchange system in an example.

FIG. 9 depicts a schematic of a user interface for use with the data interchange system in an example.

FIGS. 10A-10C depict a schematic of a user interface for use with the data interchange system in an example.

FIGS. 11A-11D depict schematics of a user interface for use with the data interchange system in an example.

FIG. 12 depicts a schematic of a user interface for use with the data interchange system in an example.

FIG. 13A-13D depict schematics of a user interface for use with the data interchange system in an example.

FIG. 14 depicts a schematic of a user interface for use with the data interchange system in an example.

FIG. 15 depicts an example of a receipt generated by the data interchange system.

FIGS. 16A and 16B are flow charts depicting specific methods of using a data interchange system to log a new transaction in an example.

FIG. 17 illustrates a block diagram of an example computing machine upon which any one or more of the techniques or methodologies discussed herein may be implemented.

### DETAILED DESCRIPTION

The present disclosure describes, among other things, methods for synchronizing intellectual property matter datasets between multiple entities, while allowing for customization. For example, multiple entities may own synchronized matter datasets containing substantially the same documents and records, but each dataset may be transformed according to the preferences of the entity. When one entity logs new information in the data interchange system, all of the synchronized matter datasets may be updated and transformed accordingly.

The updating and synchronization of matter datasets is achieved through the data interchange system acting as a common intermediary between entities. The data interchange system may transform a transaction completed within a dataset owned by a particular entity, allow entities to manipulate matter datasets according to levels of privilege granted, and communicate transactions to third parties, among other things.

As used herein, “matter dataset”, refers to information in a matter portfolio, according to one embodiment.

As used herein, “electronic communication” refers to an electronic message or a method of exchanging messages between people using electronic devices.

As used herein, “application” or “program” may include a program or piece of software designed and written to fulfill a particular purpose of the user, such as database application.

As used herein, “scraping”, “web scraping”, “data scraping”, or “web crawling” may refer to automatically mining or collecting data or information, such as from a database or from the internet.

As used herein, “dataset” may refer to a structured set of data, such as held in a computer or on the internet, that can be accessible in various ways.

As used herein, “file” or “matter” may refer to a particular project, enterprise, or undertaking being worked on by an individual or a collaborative group, planned and designed to achieve a particular aim.

As used herein, “matter dataset” may refer to a collection of documents or reports which all pertain to a particular matter. A matter dataset may contain a full history of all documents or reports which have been added to the matter dataset.

As used herein, “entity” may refer to a person or organization that has been deemed as requiring access to a particular matter dataset and has been given certain privileges to access the matter dataset.

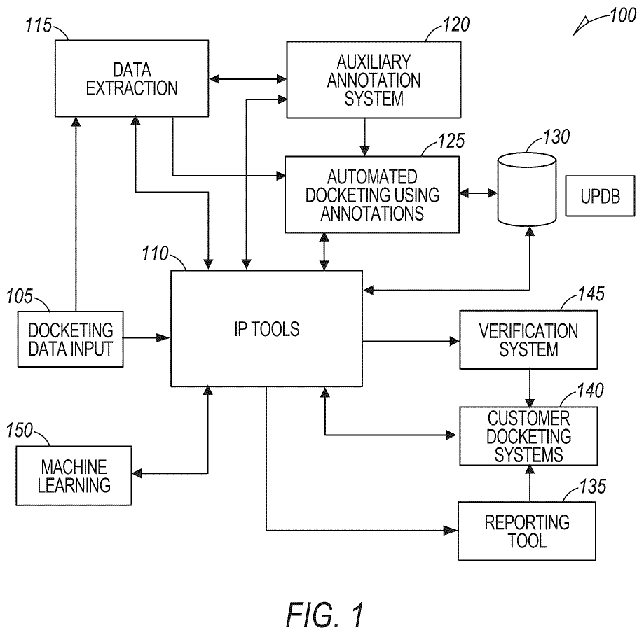

FIG. 1 is a block diagram of a docketing system 100 in an example. The docketing system 100 may be automated or semi-automated. The docketing system 100 may include docketing data input 105, docketing manager system 110, data extraction system 115, Auxiliary Annotation System 120, automated docketing tool 125, Universal Procedures Database 130, reporting tool 135, customer docketing system 140, verification system 145, and machine learning model system 150.

The docketing system 100 may receive documents from third party sources including third party docketing systems and/or customer data as docketing data input 105. The docketing manager system 110 may process the received documents to provide to the customer docketing system 140 and prepare the documents for data extraction by the data extraction system 115 as needed.

The data extraction system 115 may perform Optical Character Recognition (OCR) on the received documents from the docketing manager system 110 to extract data, read checkboxes, extract lists, and identify documents where possible. The docketing manager system 110 may also integrate with a Universal Procedures Database (UPDB) 130 to provide automated docketing by an automated docketing tool 125 that processes received documents based on the additional annotations added to the documents based on the complex data extraction performed by the Auxiliary Annotation System (AAS) 120.

The AAS 120 may further identify the received documents without using an OCR. To manage this process, the docketing manager system 110 may receive frequent updates of docketing procedure rules including configuration data and updates the UPDB 130 with universal procedure codes (UPCs) as appropriate. The UPCs may be used in conjunction with customer specific codes, checklists, and templates. The rules may specify how to fill in the templates and how to complete customer-specific procedures such as how to docket documents into the customer docketing system 140, for example. The template may be filled out by pulling in attributes from the annotations in a document.

The docketing manager system 110 may receive or intake documents and docketing data from several different sources of docketing data input 105, validate the docketing items against entries in a customer docketing system 140, and communicate those documents to the customer docketing system 140 via a unified interface. The docketing manager system 110 may also route documents and associated docketing data through the data extraction system 115 and the AAS 120 and organize the returned metadata and annotations. The docketing manager system 110 thus may provide a breakout between the metadata and the document text.

The docketing manager system 110 may also keep records and communicate with third-party application programming interfaces (APIs) to push the docketing data and documents automatically where allowed. Otherwise, the docketing manager system 110 may present the documents to human docketers to docket. The docketing manager system 110 may also issue reports upon request.

The docketing manager system 110 may be integrated with an existing docketing system (e.g., FOUNDATIONIP®), semi-integrated (e.g., CPI, ANAQUA®, etc.), may provide a virtual host that does not talk at all to the existing docketing system (e.g., IP Manager, MEMOTECH™), or may provide outputs in spreadsheet form for use by a docketing administrator to update the customer docketing system 140.

If the docketing manager system 110 and the customer docketing system 140 are not integrated, the data output of docketing system 100 may be presented to a human docketer for manual entry. For example, the human docketer may implement macros that interface with the customer docketing system 140 to populate the received data into the customer docketing system 140.

On the other hand, if the docketing manager system 110 and the customer docketing system 140 are integrated or semi-integrated, the data output may be processed to determine if any data is missing to automate the docketing process. If anything is missing, the human docketer may add that information before the automated docketing process may proceed further or the data may be auto-populated and mapped to the template from the UPDB 130.

The docketing system 100 may also perform several post-docketing actions, such as sending docketing reports/details to an external verification system 145 that use a set of rules to verify proper docketing in a host system. The verification system 145 may verify that the data is correctly added to the external customer docketing system 140. For example, the verification system 145 may pull data from the AAS 120, the docketing manager system 110, and the customer docketing system 140 to compare what is present to what is expected to be present in the respective systems.

The docketing system 100 may also provide automated “report out” email notifications to customers by implementing a reporting tool 135 that specifies docketing actions based on UPDB template configurations. The reporting tool 135 may also provide completed docketing reports to customers either directly or via the customer docketing system 140.

In some cases, machine learning techniques may be used to generate annotations. For example, a database of past documents that have been identified may be provided by the docketing manager system 110 and used as a data warehouse to train and improve machine learning models by creating a training set for the machine learning model. Over time, the machine learning model system 150 can learn which Patent and Trademark Office (PTO) IDs to use for which documents, which document in a bundle of documents may be used to characterize the bundle, and may provide predicted PTO IDs for the received documents. The machine learning model system 150 may also establish rule engine prediction capabilities for received documents that test the classifications.

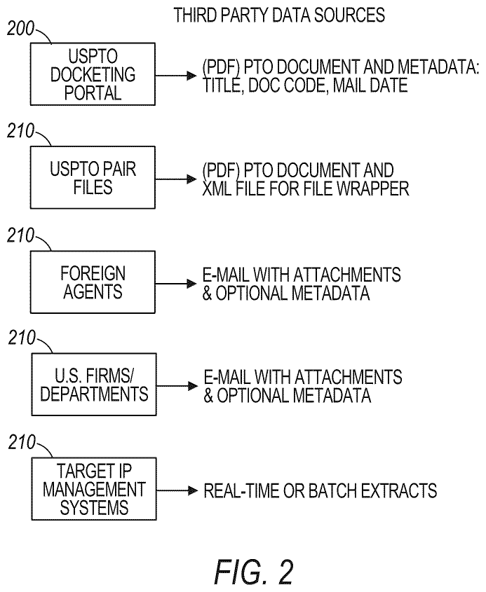

FIG. 2 illustrates sample third-party data sources that provide data input for a data interchange system. As illustrated in FIG. 2, the third-party data sources may include a national patent or trademark office (PTO) docketing portal 200, which provides documents from the PTO in portable document format (PDF) and includes metadata identifying the title, document code, and mail date for the corresponding document. The third-party data sources may further include PTO PAIR extensible markup language (XML) files 210, which provide documents from the PTO in PDF and includes an XML file for patent or trademark file wrappers. The third-party data sources may also include foreign agents 220 who provide emails with attachments and optional metadata.

Foreign agents 220 may also provide hard copy documents that may be scanned for data entry. Similarly, law firms and/or corporate law departments 230 may provide emails with attachments and optional metadata as well as hard copy documents that may be scanned for data entry. Also, third-party docketing systems 240 may provide real-time or batch extracts of data for entry into a docketing management system.

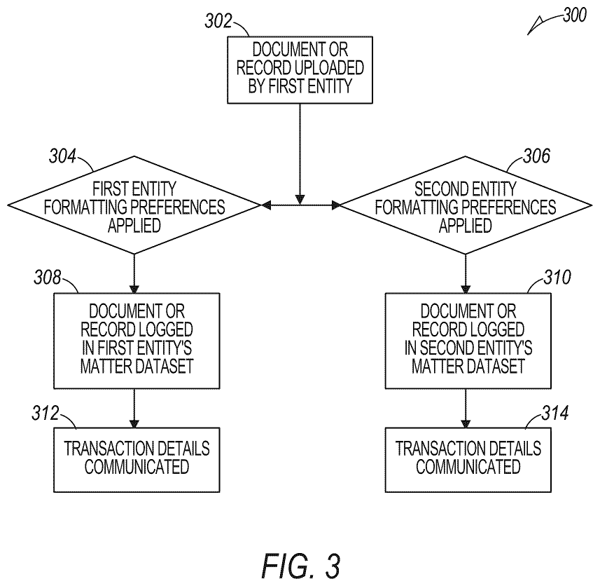

FIG. 3 is an illustration of a process 300 for creating synchronized matter datasets with individualized preferences.

At operation 302, the first entity may upload a document or record into a matter dataset located within the data interchange system as part of a transaction. A transaction being logged by the data interchange system may contain multiple pieces of information relating to a particular matter. For example, a transaction may include a document or record, due date, associated values or attributes, category designations, or other information relating to a particular matter.

The first entity may retain ownership privileges in the matter dataset. Ownership privileges may include the ability to delete a document or record, to dictate how the document or record may be transformed, and control who receives communication regarding the logging of the document or record. In one embodiment, the document or record may pertain to a matter that is of interest to a second, third, or more, entity.

At operation 304, the document or record is transformed according to the preferences of the first entity. Transformation according to preferences may include formatting updates, translation, changing terminology, updating filing numbers, detecting errors in filing dates, or other nuances that have been indicated by the entity.

At operation 306, the document or record may be transformed according to the preferences of the second entity. Additional operations similar to 304 and 306 may occur for the number of entities that have privileges to dictate the transformation of documents or records in the matter dataset.

At operation 308 the document or record may be logged as a transaction in the matter dataset of the first entity. The first entity dataset contains the same documents or records as the second or more entities datasets. However, differences between the datasets may exist in terms of formatting and may exist when the entity with ownership privileges is engaged in litigation or other similar circumstances.

At operation 310 the document or record is logged in the matter dataset of the second entity.

At operation 312 the details of the transaction may be communicated to third parties that have been identified by the first entity.

At operation 314 the details of the transaction may be communicated to third parties that have been identified by the second entity. In other embodiments, the details of a transaction may be communicated to third parties that have been identified by a third, fourth, or more entity.

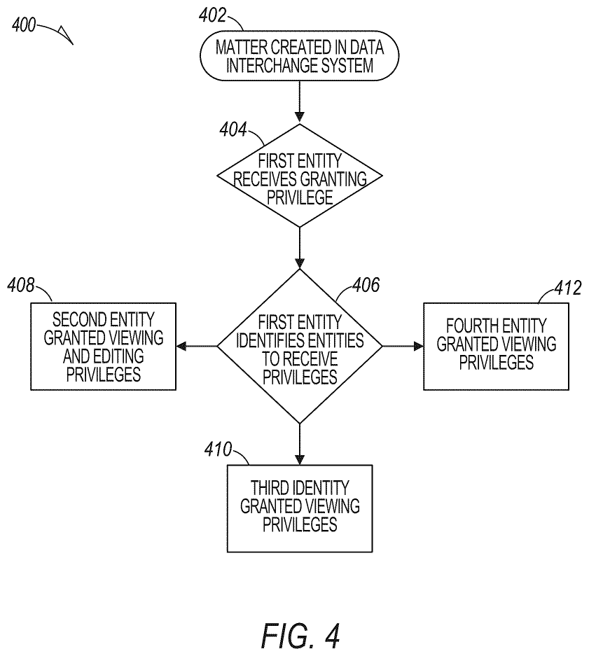

FIG. 4 is a flow chart depicting a process 400 for granting privileges to entities.

At operation 403 a matter may be created in the data interchange system. A matter may be, for example, a patent application going through prosecution with a national patent office.

At operation 404 a first entity may be identified as having the ability to grant privileges to other additional entities.

At operation 406 the first entity may identify additional entities to receive privileges. Multiple entities may be identified to receive privileges. As shown in FIG. 4, for example, a second, third, and fourth entity is identified as receiving privileges.

At operation 408 the second entity may be granted the privileges of viewing and editing a matter, for example.

At operation 410 the third entity may be granted the privilege of viewing a matter, for example.

At operation 412 the fourth entity may be granted the privilege of viewing a matter, for example.

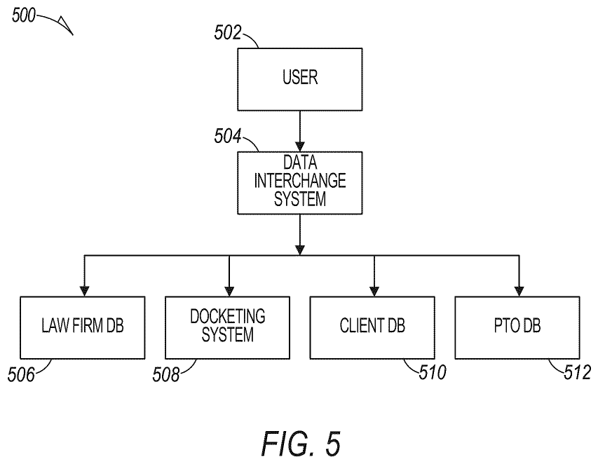

FIG. 5 is a flow chart depicting a process of distributing information from a user, through the data interchange system, and out to various end sources. In process 500 a user 502 may log into the data interchange system 504 and log a transaction containing documents or records and associated values in a matter dataset.

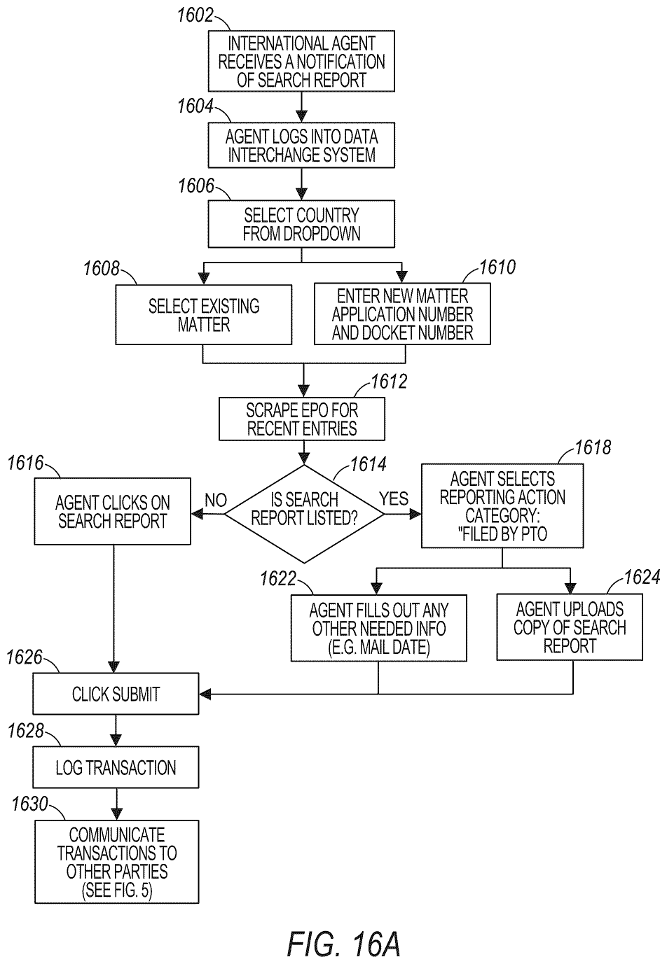

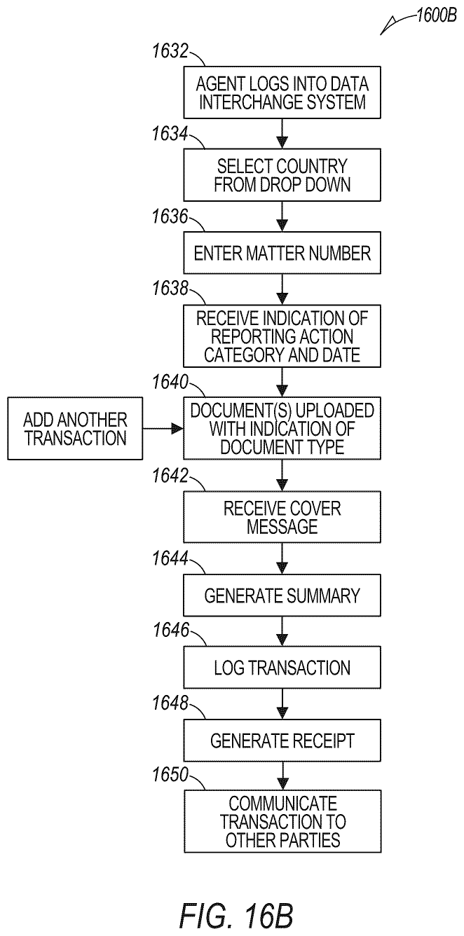

In another embodiment, process 500 may be initiated upon receipt of an electronic communication regarding a particular matter and necessary action to be completed by a due date. The data interchange system may execute a method similar to methods described in FIGS. 16A and 16B below by referencing the information included in an electronic communication without requiring a user to log in and provide it themselves.

A user 502 may be granted certain privileges for interacting with a matter dataset located within the data interchange system 504. Privileges may include ownership, viewing, editing, or any combination thereof.

The data interchange system 504 may communicate a transaction logged into the system. The communication may be an electronic communication to end sources as identified by the entity privileged to do so. When a transaction is logged into the system, it may be transformed according to the preferences of the entities identified as having the privilege to dictate transformation. If multiple entities have such privileges, a matter dataset will be created for those entities, each containing a history of transactions logged by any entity with the privilege to complete a transaction. However, the transactions found in each matter dataset may only be transformed according to the preferences of the entity privileged to dictate transformation.

The transaction may be logged in multiple matter datasets located within the data interchange system 504. The data interchange system 504 may identify one or more matters having a corresponding matter dataset which the transaction pertains to. For example, when logging a matter transaction including an official office action sent by the USPTO, the data interchange system 504 may identify all attorneys located in the United States which are associated with the matter as entities who should receive the transaction in the associated matter dataset.

A law firm database 506 may be identified as an end source and may receive communications regarding a transaction.

A docketing system 508 may be identified as an end source and may receive communications regarding a transaction.

A client database 510 may be identified as an end source and may receive communications regarding a transaction.

A patent office database 512 may be identified as an end source and may receive communications regarding a transaction.

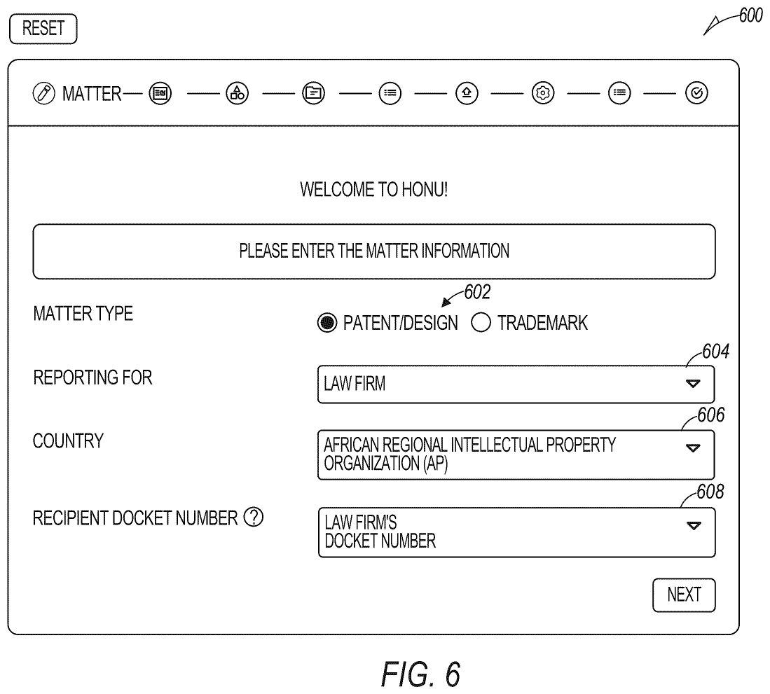

Any of the following user interfaces as described in FIGS. 6-9, 10A-C, 11A-D, 12, 13A-D, and 14 may be, for example, an application or program on a computer, such as a web-based software, or a locally saved program. The user interface may be interactive with a mouse and keyboard, or with a touchscreen, or a combination thereof.

FIG. 6 depicts a schematic of a user interface 600 for a data interchange system in an example. The user interface 600 may be, for example, a landing page for the data interchange system.

At operation 602, the data interchange system may prompt the user to select either a patent/design matter or a trademark matter.

At operation 604 the data interchange system may prompt the user to select a customer that the document or report is being reported for. A customer may be, for example, a law firm or docketing department that is managing communications relating to the matter.

At operation 606, the data interchanges system may prompt the user to select a country for which the document or report was filed in or communicated from. For example, the user may select the European Patent Office to log a document that was communicated from the European Patent Office.

At operation 608, the data interchange system may prompt the user to enter a docketing number. The docketing number may be a number assigned by the customer and identifying a matter based on the matter identification system of a customer. The data interchange system may recognize a particular matter based on either a docketing number or an application number.

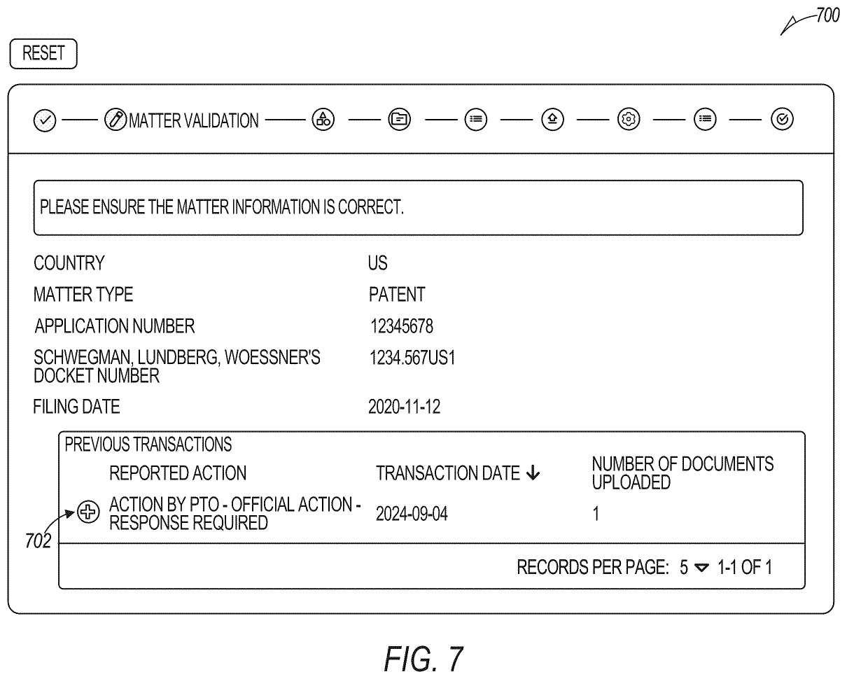

FIG. 7 depicts a schematic of a user interface 700 for a data interchange system in an example. The user interface 700 may be, for example, a Matter Validation page for the data interchange system.

User interface 700 may display matter information for the user to ensure its accuracy. Prior to displaying user interface 700 the data interchange system may scrape either the national patent office database or an internal database to determine the correct filing date and other information for the matter identified at operation 606. For example, the country, matter type, application number, docketing number, filing date, and previous transactions are displayed to the user. If the Application Number is not displayed, the data interchange system may prompt the user to provide it.

At operation 702 the data interchange system may list previous transactions that were found during the scrape of the national patent office of internal database. The data interchange system may keep a record of all documents or reports that have been uploaded in regard to the matter identified at operation 606. For example, user interface 700 shows one previous transaction, an Action by PTO, the date that the transaction took place, and the number of documents that have been uploaded to the data interchange system relating to that action.

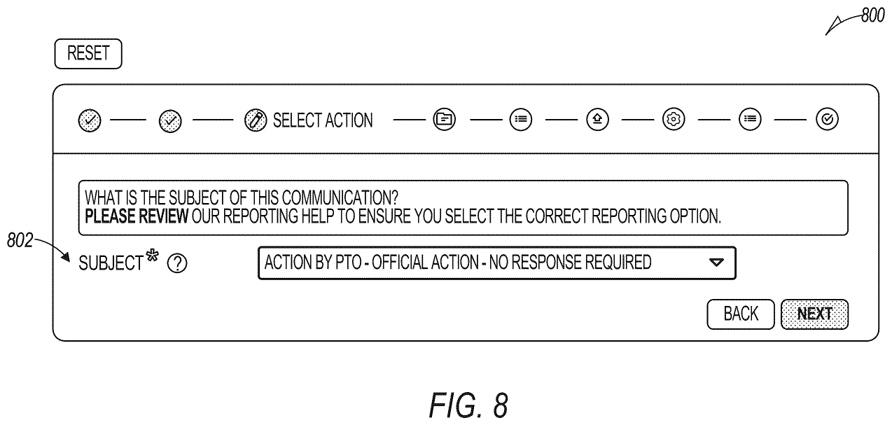

FIG. 8 depicts a schematic of a user interface 800 for a data interchange system in an example. The user interface 800 may be, for example, a Select Action page for the data interchange system.

User interface 800 may prompt the user to identify the subject of the communication reported. The subject of the communication may be a category that relates to the source of the document or record being reported. A drop-down menu is presented containing the options Action by PTO, Items Filed, New Application, Other Communications and Requests, and Reminders, for example.

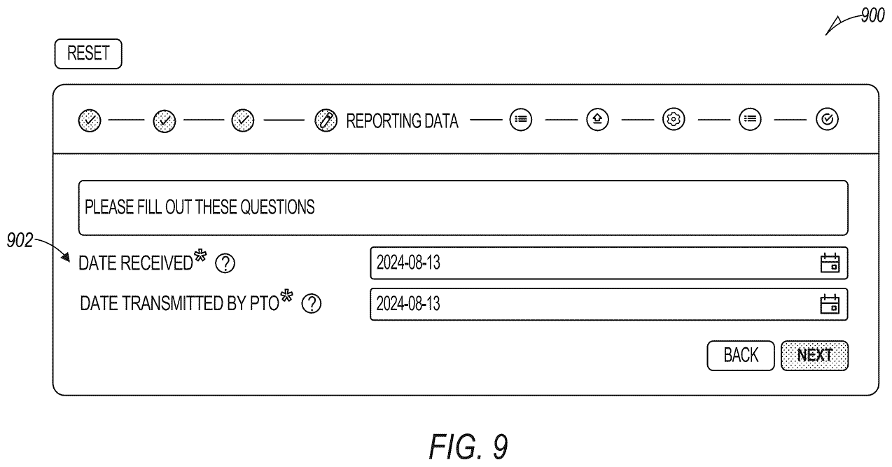

FIG. 9 depicts a schematic of a user interface 900 for a data interchange system in an example. The user interface 900 may be, for example, a Reporting Data page for the data interchange system.

At operation 902 the data interchange system may prompt the user to provide additional information regarding the action being reported. For example, a user may be prompted to provide the date that the firm received the action being reported or the date that it was transmitted by an official entity, such as the PTO.

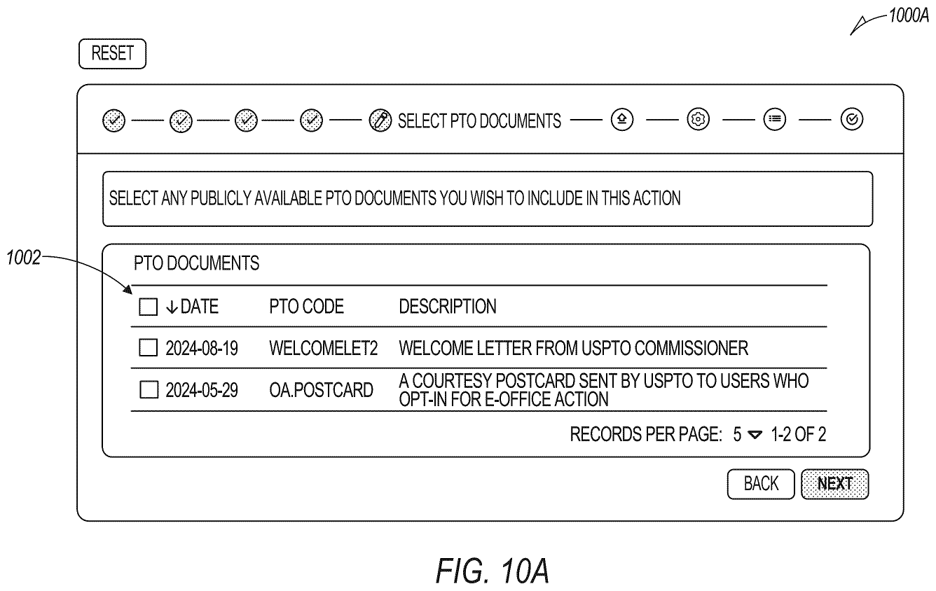

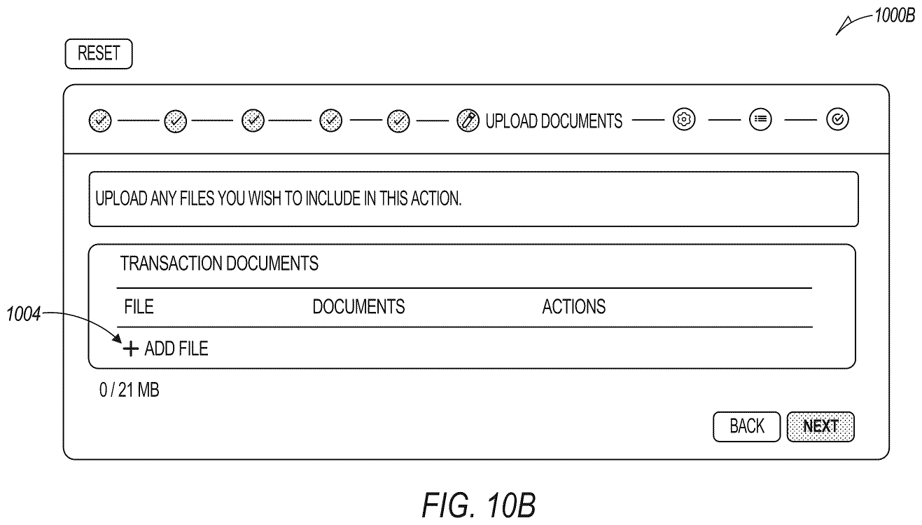

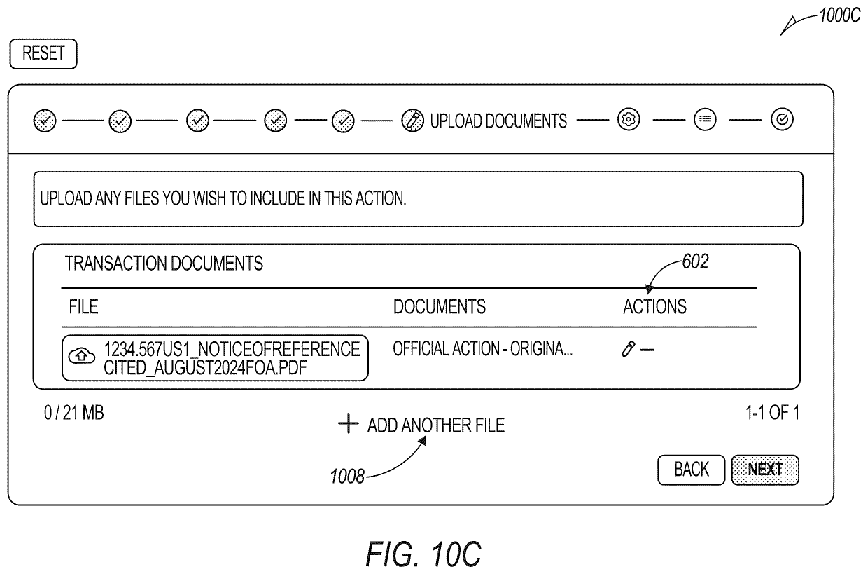

FIGS. 10A-10C depict a process of completing a transaction in the data interchange system by selecting a publicly available PTO document and/or uploading a related document.

FIG. 10A depicts a schematic of a user interface 1000A for a data interchange system in an example. The user interface 1000A may be, for example, a Select PTO Documents page for the data interchange system.

User interface 1000A may display, for example, all publicly available documents from national patent offices which relate to the matter identified at user interface 700.

Displayed at 1002 may be a list of publicly available documents issued by national patent offices which relate to the identified matter. The data interchange system may prompt the user to select any documents from the list that they would like to include in the action. For example, FIG. 10A lists two publicly available documents from the PTO that a user may include in the action being recorded.

Also displayed at 1002 for each document listed may be issuance date, PTO code, and description, for example. The description may correspond with the title of the document as given by the national patent office.

In another embodiment, user interface 1000A may not display any publicly available PTO documents if none have been issued.

FIG. 10B depicts a schematic of a user interface 1000B for a data interchange system in an example. The user interface 1000B may be, for example, an Upload Documents page prior to any documents being uploaded to the data interchange system.

User interface 1000B may display to the user a file, a description of the file, and actions.

Operation 1004 may allow the user to upload documents which correspond with indications received at user interfaces 800-1000A, for example.

In another embodiment, user interface 1000B may not be displayed for the user, as the data interchange system may download the document or record being logged directly from the national patent office.

FIG. 10C depicts a schematic of a user interface 1000C for a data interchange system in an example. The user interface 1000C may be, for example, an Upload Documents page after a completed upload for the data interchange system.

Operation 1006 represents possible actions available to a user. Operation 1006 may allow the user to remove a file that was uploaded and provides additional means to upload a document. The document may be uploaded under operations 1004 or 1006. If the document is uploaded under operation 1004, the data interchange system may give the user the option to edit data associated with the document such as the document type, date filed, PTO code, and description, for example.

At operation 1008 the data interchange system may prompt the user to upload additional documents for the transaction, if desired. Additional documents may include further communications from a national patent office, electronic communications between entities, associated drawings or figures, or any other document.

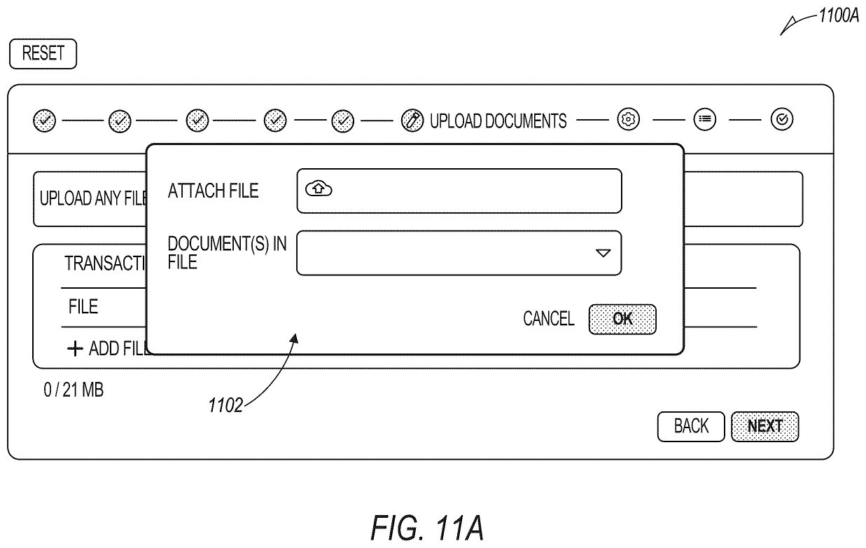

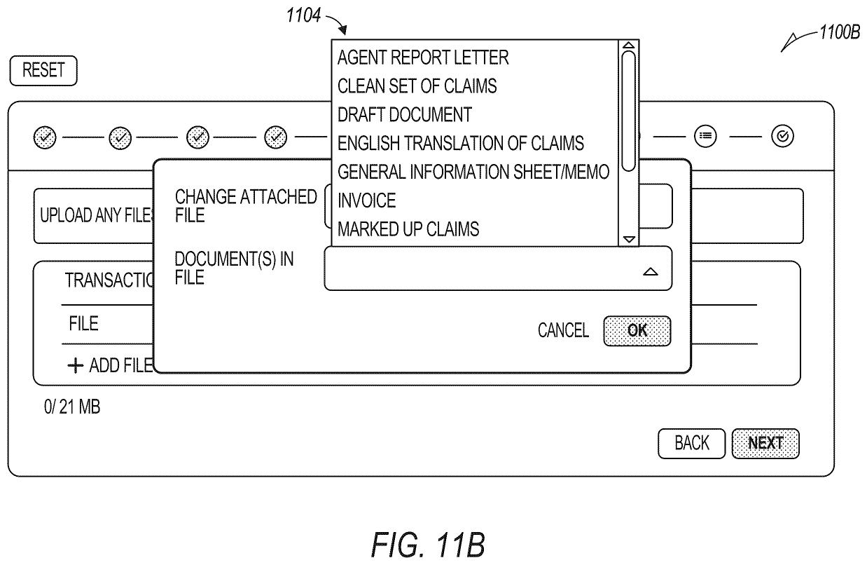

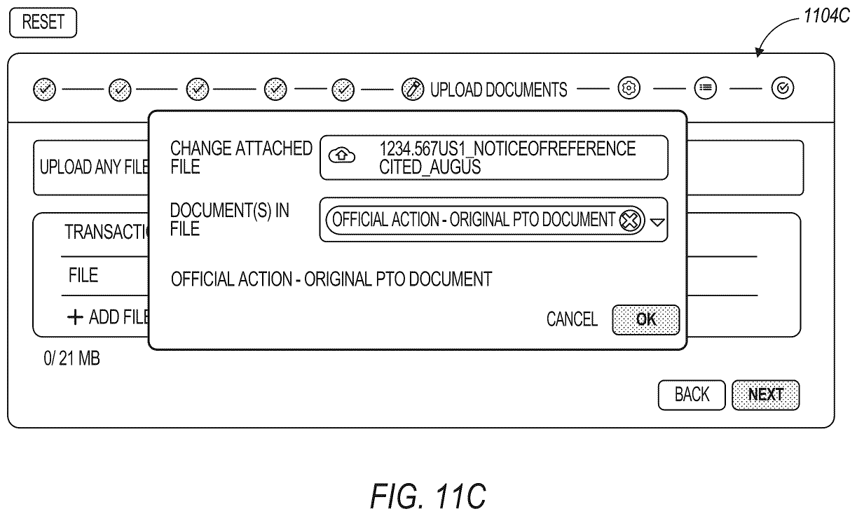

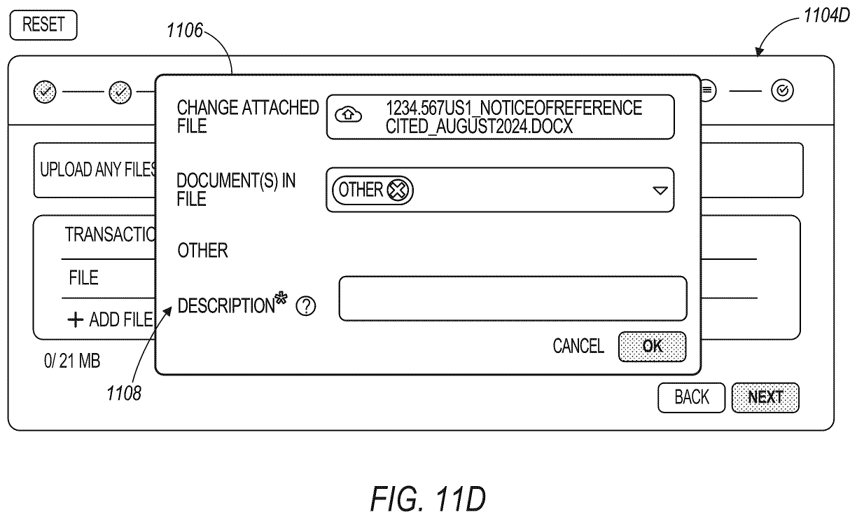

FIG. 11A depicts a schematic of a user interface 1100A for a data interchange system in an example. The user interface 1100A may be, for example, prompting the user to upload an additional document for the transaction depicted in FIGS. 6-10C for the data interchange system.

At operation 1102 the data interchange system may prompt the user to attach a file and select a document type from a drop down menu for the additional document

FIG. 11B depicts a schematic of a user interface 1100B for a data interchange system in an example. The user interface 1100B may be, for example, a page prompting the user to select a document type for the transaction. The document type is a subcategory for further identifying the document or record.

At operation 1104 the data interchange system may list possible document types for the additional document to be added to a transaction. Possible document types may be, for example, agent report letter, clean set of claims, draft document, English translation of claims, general information, invoice, marked up claims, or other.

The document types available for the user to select at operation 1104 depends on the reporting action category identified at operation 802. For example, when the reporting action category provided is Issue Fee Paid, the subcategories available may be agent report letter, prior art reference: non-patent literature, prior art reference: patent literature, signed document or document requiring signature, and other. In contrast, when the reporting action category chosen is Action by PTO: Office Action Response Required additional subcategories may be available, such as official action—original PTO document, official action-translated, and patent granted.

FIG. 11C depicts a schematic of a user interface 1100C for a data interchange system in an example. The user interface 1100C may be, for example, a page displaying the selected document type and a successfully uploaded document. For example, user interface 1100C shows an uploaded document designated as an Official action—Original PTO Document.

FIG. 11D depicts a schematic of a user interface 1100D for a data interchange system in an example. The user interface 100D may be, for example, a page prompting a user to upload a second document for the action being reported. A user may access this page by selecting “add another file” at operation 1008.

At operation 1106, the user interface may display the attached file and a drop down menu for designating a document type. For example, user interface 1100D shows a new document uploaded for the data interchange system, designated with file type “Other”.

Upon receiving a selection of file type “Other”, the data interchange system may prompt the user to provide a description for the document at operation 1108. A description for the document designated as “Other” may be, for example, “email with foreign agent”, “updated figures”, or any description of a communication or document relating to the identified matter.

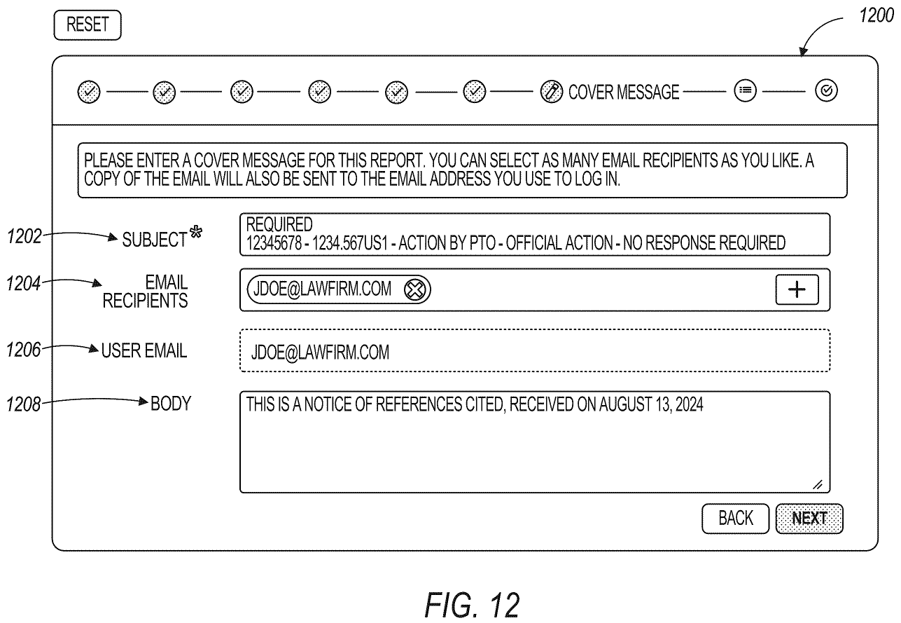

FIG. 12 depicts a schematic of a user interface 1200 for a data interchange system in an example. The user interface 1300 may be, for example, a Cover Message page for the data interchange system.

User interface 1200 may prompt the user to provide information to include in a cover message for the transaction. The cover message may be included in electronic communications sent to parties as indicated by the first, second, or more, entities with the privilege of designating parties to receive communications. Parties who are designated to receive this electronic communication generally may include, for example, paralegals and docketing departments. Each matter may store a list of parties which have been designated to receive electronic communications.

At operation 1202 the user may be prompted to include a subject line for the cover message.

At operation 1204 the user may be prompted to provide email addresses for any additional parties they intend to receive electronic communications regarding the action being reported.

At operation 1206 the user may be prompted to provide their own email address as the sender of email communications regarding the action being reported.

At operation 1208 the user may be prompted to include a body of text for the cover message.

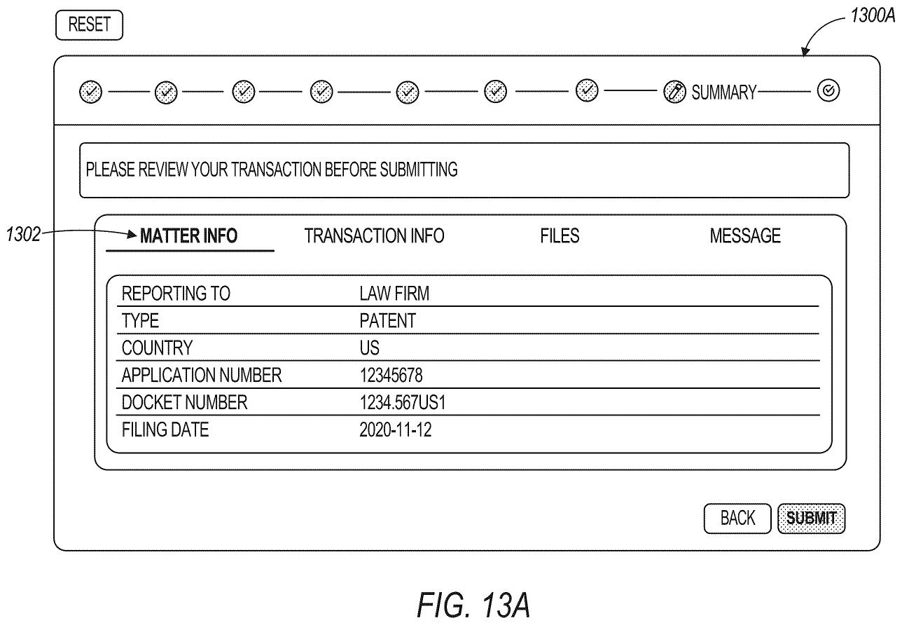

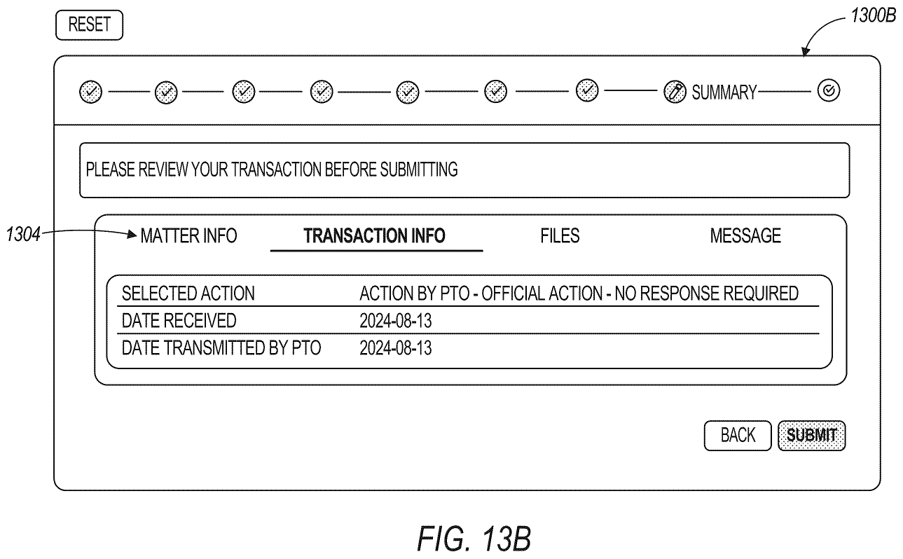

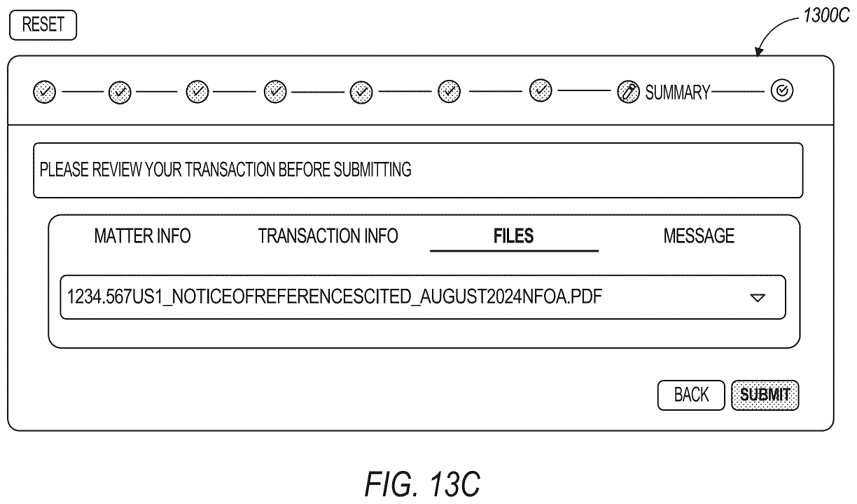

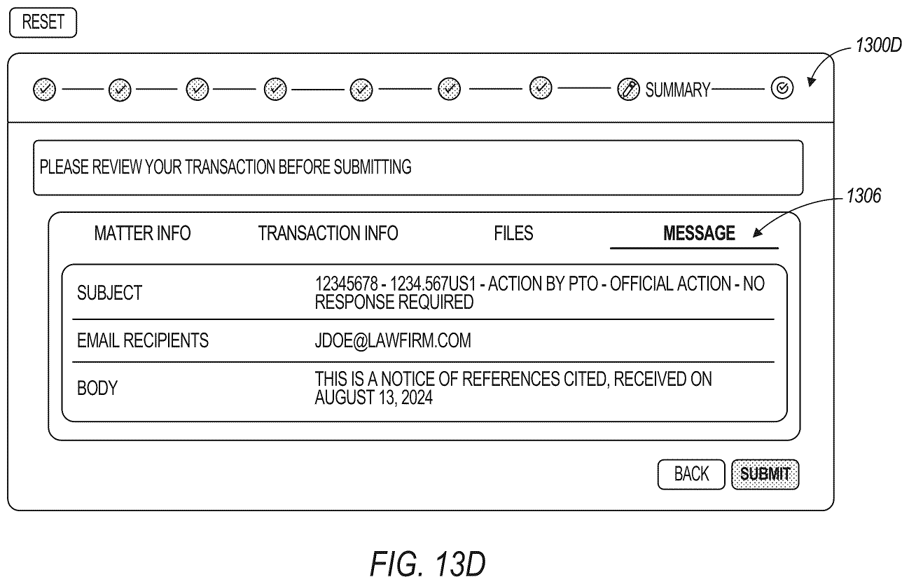

FIG. 13A depicts a schematic of a user interface 1300A for a data interchange system in an example. The user interface 1400 may be, for example, a Summary page for the data interchange system displaying matter information for the action being reported.

At operation 1302, user interface 1300A may display to the user a summary of matter information currently being reported. Matter information may include the customer that the action is being reported to, the action type, the country associated with the action, the application number, the docketing number, and the filing date, for example.

FIG. 13B depicts a schematic of a user interface 1300B for a data interchange system in an example. The user interface 1300B may be, for example, a Summary page for the data interchange system displaying transaction information for the action being reported.

At operation 1304, user interface 1300B may display to the user a summary of the transaction information currently being reported. Transaction information may include the subject of the action, the date the action was received, and the date that the action was transmitted by the PTO, for example.

FIG. 13C depicts a schematic of a user interface 1300C for a data interchange system in an example. The user interface 1300C may be, for example, a Summary page for the data interchange system displaying files previously uploaded for the action being reported.

FIG. 13D depicts a schematic of a user interface 1300D for a data interchange system in an example. The user interface 1300D may be, for example, a Summary page for the data interchange system displaying the message to be sent with the action being reported.

At operation 1306, user interface 1300D may display to the user a summary of the message to be sent with the action being reported. The message summary may include, for example, a subject, a list of email recipients, and a body of the message.

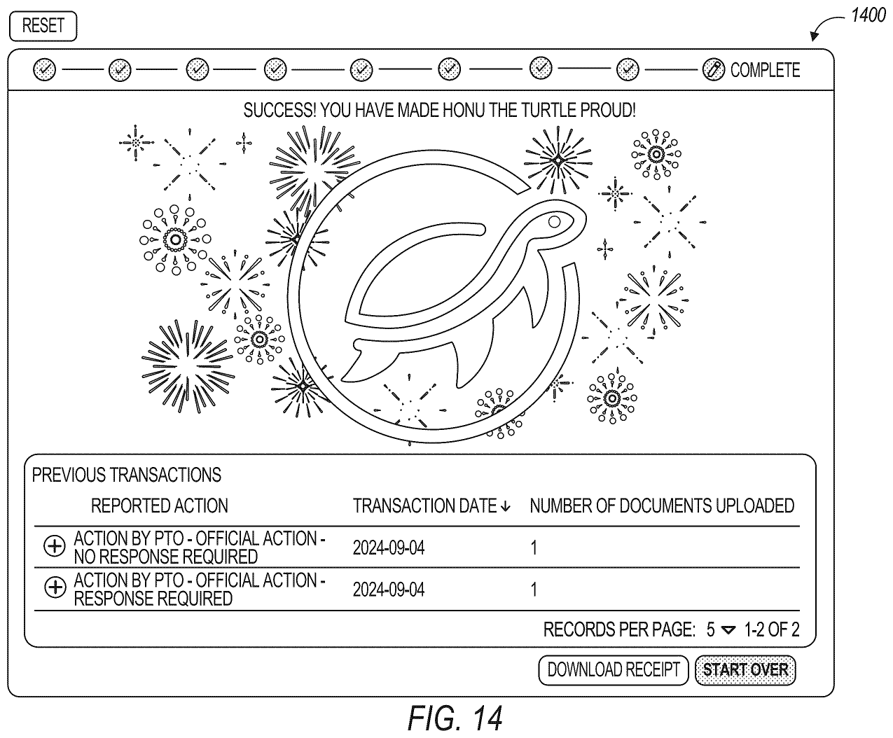

FIG. 14 depicts a schematic of a user interface 1400 for a data interchange system in an example. The user interface 1400 may be, for example, a Complete page for a transaction containing two previous transactions, each containing one uploaded document. Any number of documents may be uploaded to the data interchange system for each transaction.

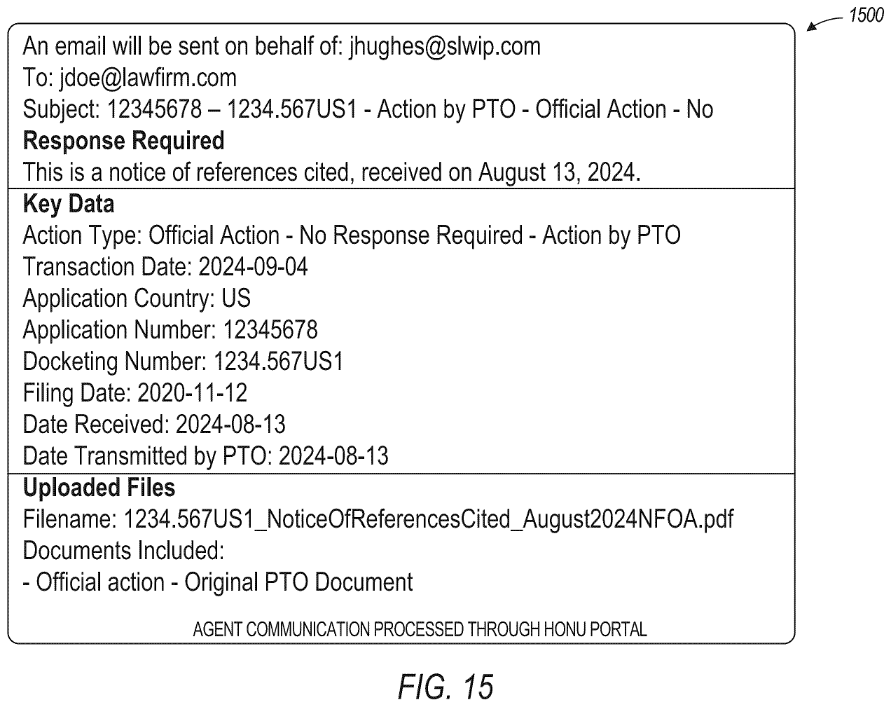

FIG. 15 depicts an example of a receipt 1500 generated by the data interchange system after successfully completing a transaction.

Receipt 1500 may indicate details about the email communication, key data about the transaction, and files uploaded to the data interchange system as part of the transaction, for example.

FIGS. 16A and 16B are flow charts depicting example methods of aggregating information in a data interchange system, where the system may be used with a calendaring system for matters having due dates. The system may be accessible by an entity privileged to do so. The privilege to access the matter dataset may include at least one of owning, viewing, editing, deleting, exporting, and communication documents stored within their matter dataset. These privileges may be revokable or reassignable by a first entity.

FIG. 16A is a flow chart depicting the data interchange system logging an example entry by implementing a specific method 1600A. In method 1600A, a data interchange system may log a record and associated values in a matter dataset. The data interchange system may then communicate the logging of the transaction to parties as indicated by the entity privileged to do so.

The matter dataset being updated in method 1600A may include a collection of documents and information associated with a matter. The matter dataset may be managed by the entity with ownership privileges, for example.

Method 1600A may be used, for example, in the context of a law firm coordinating with multiple entities in different locations. The entities may be filing related cases in different patent offices such as the United States Patent and Trademark Office (USPTO) and the European Patent Office (EPO).

At operation 1602, a non-US agent may receive a notification that a document or report relating to their case was published. This notification may be an electronic communication received from a national patent office.

At operation 1604, the non-US agent may log into the data interchange system using a personalized login credentials. The personalized login credentials may be configured to grant certain privileges depending on the level of access intended for the non-US agent. For example, the privilege of owning a matter may enable an entity to grant privileges to additional entities, delete documents, identify preferences, and identify third parties to receive transaction communications. The privilege of exporting, on the other hand, may enable an entity to create an identical copy of a matter dataset to be pushed into an outside system owned by an entity with privilege to access the matter.

At operation 1606, the data interchange system may display a drop-down menu containing a list of countries. An indication may be received from the non-US agent of the country that the document being reported corresponds to.

At operation 1608, the data interchange system may identify matters by filtering a plurality of matters, and display the identified matters based off the upload history of the non-US agent for the non-US agent to select from. Filtering the plurality of matters may comprise receiving an indication of at least one of a country in which a patent application has been filed, application number, docket number, or an existing matter number. This list may only contain matters which the non-US agent is privileged to own, view, and/or edit.

If the matter being edited is not listed in the drop-down menu at operation 1608, the non-US agent may provide a new application number or docketing number at operation 1610.

At operation 1612, the data interchange system may scrape the patent office website of the country indicated at operation 1606 to locate recently published documents which correspond with the application or docketing number collected at operations 1608 or 1610.

At operation 1614, the data interchange system may display the records pulled from the data scrape of the appropriate patent office.

At operation 1616 the data interchange system may receive an indication from the non-US agent of which report being displayed is the intended document to be logged in the matter dataset. The intended document may include due dates and associated values or attributes. Document attributes may include at least one of a filing date, communication date, status, patent number, country, or bibliographic information.

At operation 1618 the data interchange system may display reporting action categories for the agent to select from a drop-down menu if the search report is not listed at operation 1614. Reporting action categories may be categories relating to the source of the document or record being logged, such as a document filed in a patent office, a document received from a patent office, or a validation. At operation 1618, for example, the non-US agent may select “Filed by PTO”, “Filed in PTO”, “Validation”, or other categories.

The data interchange system may request different information from the user depending on the type of reporting action selected. Reporting action categories may be provided for both published and unpublished patent applications.

At operation 1620, the data interchange system may display a drop-down menu with subcategories describing the document type. The subcategories listed correspond to the reporting action category selection received at operation 1618. The subcategories may include reporting letter, foreign search opinion, notice of publication, description, specification, claims, drawings, abstract, national patent office information, claim translation, acknowledgement of receipt, or other documents relating to a matter. If the subcategory selected is “other”, the data interchange system may prompt the non-US agent to enter a description for the document type.

At operation 1622, the data interchange system may display fields for the non-US agent to input additional information such as mail date, filing date, or other bibliographic information.

At operation 1624, the data interchange system will receive an upload of the document or report.

At operation 1626 a submit button will be presented which the non-US agent will use to indicate the transaction should be logged in the data interchange system.

At operation 1628, the data interchange system may log the transaction within the matter dataset of the non-US agent. The transaction may be logged according to the indicated source category and subcategory and may include a document or report and associated attributes. Prior to logging, the transaction may be transformed according to preferences as indicated by the entity privileged to dictate transformation. Transformation may include formatting updates, translation, terminology edits, updating of filing numbers, detecting of errors in deadlines, or other formatting nuances.

Logging the transaction may also include identifying entities which the transaction pertains to. A transaction may pertain to an entity if they have been granted privileges to a particular matter. Therefore, a transaction may be logged in multiple entity matter datasets simultaneously, and transformed according to preferences unique to the entity associated with the matter.

The data interchange system may use other information about an entity to determine whether the transaction should be logged in a matter dataset which the entity has privileges to access. Other information which may be used in the determination includes the location of an entity, the type of entity, or other attributes of an entity.

The data interchange system may also use information about the document being uploaded to determine whether it should be logged in a particular entity's associated matter dataset. Such information may include the type of document, where the document originated, a deadline for responding to the document, or other attributes.

When a transaction is logged within a particular entity matter dataset, the transaction may also be duplicated to another entity matter dataset. When a transaction is duplicated to another entity matter dataset it may be transformed according to the preferences of that entity. In this way, multiple personalized and synchronized matter datasets may be maintained for different entities. The multiple personalized and synchronized matter dataset history may be preserved by the data interchange system.

At operation 1630, the data interchange system may communicate the transaction to the identified third parties. Communications to the identified third parties may include the document or record, a source category and document attributes.

FIG. 16B is a flow chart depicting the data interchange system logging an example transaction by implementing a specific method 1600B. In method 1600B, the agent may be logging a transaction in the data interchange system. Method 1600B may include the agent uploading a document which is not publicly available in a national patent office.

At operation 1632 the agent may log into the data interchange system. The agent may have been granted certain privileges prior to logging in. In method 1600 the agent has at least the privilege of viewing and editing a matter.

At operation 1634, the data interchange system may receive an indication of a country from the agent. The country indicated may be the country in which a patent application is filed with the national patent office.

At operation 1636, the data interchange system may receive an indication of a matter number, for example. The matter number may be a number which has been assigned by the agent's organization, for example. The matter number may also be an application number which had been assigned by a national patent office, for example.

At operation 1638, the data interchange system may receive an indication of a reporting action category and date, for example.

At operation 1640, a document associated with the transaction may be uploaded to the data interchange system. The data interchange system may receive an indication of a subcategory for the document through the selection of a document type from a drop-down menu. At this point, the agent may also add an additional document to the transaction.

At operation 1642 the data interchange system may prompt the agent to provide information to be included in a cover message for the transaction.

At operation 1644 the data interchange system may generate a summary of the transaction for the agent to review. At this point, the agent may choose to add another document to the transaction. In which case, the data interchange system may navigate the agent back to operation 1640 to upload the new document and select a document type subcategory.

At operation 1646 the data interchange system may log the transaction. Logging may include transforming the transaction according to preferences as indicated by the entity privileged to dictate transformation preferences.

The transaction may be logged in multiple matter datasets simultaneously. The data interchange system may determine which matter dataset to log the transaction based on which entities have been granted privileges to access the matter.

At operation 1648 the data interchange system may generate a receipt containing all pertinent information regarding the transaction.

At operation 1650 the data interchange system may communicate the transaction to parties indicated by the entity privileged to identify parties to receive the communication.

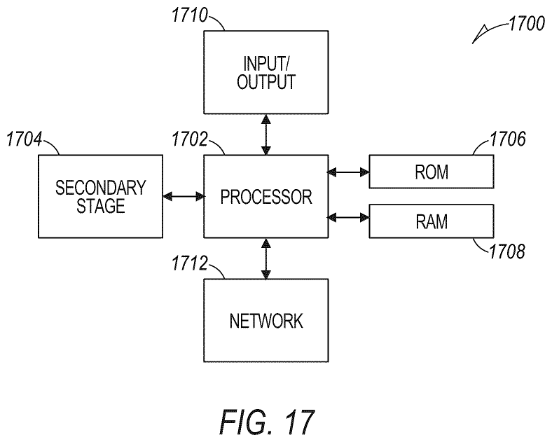

FIG. 17 is a block diagram of a typical, general-purpose computer 1700 that may be programmed into a special purpose computer suitable for implementing one or more embodiments of the data interchange system disclosed herein. The data interchange system described above may be implemented on any general-purpose processing component, such as a computer with sufficient processing power, memory resources, and communications throughput capability to handle the necessary workload placed upon it. The computer 1700 include a processor 1702 (which may be referred to as a central processor unit or CPU) that is in communication with memory devices including secondary storage 1704, read only memory (ROM) 1706, random access memory (RAM) 1708, input/output (I/O) devices 1710, and network connectivity devices 1712. The processor 1702 may be implemented as one or more CPU chips or may be part of one or more application specific integrated circuits (ASICs).

The secondary storage 1704 is typically comprised of one or more disk drives or tape drives and is used for non-volatile storage of data and as an over-flow data storage device if RAM 1708 is not large enough to hold all working data. Secondary storage 1704 may be used to store programs that are loaded into RAM 1708 when such programs are selected for execution. The ROM 1706 is used to store instructions and perhaps data that are read during program execution. ROM 1706 is a non-volatile memory device that typically has a small memory capacity relative to the larger memory capacity of secondary storage 1704. The RAM 1708 is used to store volatile data and perhaps to store instructions. Access to both ROM 1706 and RAM 1708 is typically faster than to secondary storage 1704.

The devices described herein may be configured to include computer-readable non-transitory media storing computer-readable instructions and one or more processors coupled to the memory, and when executing the computer-readable instructions configure the computer 1700 to perform method steps and operations described above with reference to FIG. 3 to FIG. 16B. The computer-readable non-transitory media includes all types of computer-readable media, including magnetic storage media, optical storage media, flash media, and solid-state storage media.

It should be further understood that software including one or more computer-executable instructions that facilitate processing and operations as described above with reference to any one or all of steps of the disclosure may be installed in and sold with one or more servers and/or one or more routers and/or one or more devices within consumer and/or producer domains consistent with the disclosure. Alternatively, the software may be obtained and loaded into one or more servers and/or one or more routers and/or one or more devices within consumer and/or producer domains consistent with the disclosure, including obtaining the software through physical medium or distribution system, including, for example, from a server owned by the software creator or from a server not owned but used by the software creator. The software may be stored on a server for distribution over the Internet, for example.

Also, it will be understood by one skilled in the art that this disclosure is not limited in its application to the details of construction and the arrangement of components set forth in the description or illustrated in the drawings. The embodiments herein are capable of other embodiments, and capable of being practiced or carried out in various ways. Also, it will be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. Further, terms such as up, down, bottom, and top are relative, and are employed to aid illustration, but are not limiting.

The components of the illustrative devices, systems and methods employed in accordance with the illustrated embodiments may be implemented, at least in part, in digital electronic circuitry, analog electronic circuitry, or in computer hardware, firmware, software, or in combinations of them. These components may be implemented, for example, as a computing program product such as a computing program, program code or computer instructions tangibly embodied in an information carrier, or in a machine-readable storage device, for execution by, or to control the operation of, data processing apparatus such as a programmable processor, a computer, or multiple computers.

A computing program may be written in any form of programming language, including compiled or interpreted languages, and it may be deployed in any form, including as a stand-alone program or as a module, component, subroutine, or other unit suitable for use in a computing environment. A computing program may be deployed to be executed on one computer or on multiple computers at one site or distributed across multiple sites and interconnected by a communication network. Also, functional programs, codes, and code segments for accomplishing the techniques described herein may be easily construed as within the scope of the present disclosure by programmers skilled in the art. Method steps associated with the illustrative embodiments may be performed by one or more programmable processors executing a computing program, code or instructions to perform functions (e.g., by operating on input data and/or generating an output). Method steps may also be performed by, and apparatus may be implemented as, special purpose logic circuitry, e.g., an FPGA (field programmable gate array) or an ASIC (application-specific integrated circuit), for example.

The various illustrative logical blocks, modules, and circuits described in connection with the embodiments disclosed herein may be implemented or performed with a general-purpose processor, a digital signal processor (DSP), an ASIC, a FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Processors suitable for the execution of a computing program include, by way of example, both general and special purpose microprocessors, and any one or more processors of any kind of digital computer. Generally, a processor will receive instructions and data from a read-only memory or a random-access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computing program instructions and data include all forms of non-volatile memory, including by way of example, semiconductor memory devices, e.g., electrically programmable read-only memory or ROM (EPROM), electrically erasable programmable ROM (EEPROM), flash memory devices, and data storage disks (e.g., magnetic disks, internal hard disks, or removable disks, magneto-optical disks, and CD-ROM and DVD-ROM disks). The processor and the memory may be supplemented by or incorporated in special purpose logic circuitry.

Those of skill in the art understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure. A software module may reside in random access memory (RAM), flash memory, ROM, EPROM, EEPROM, registers, hard disk, a removable disk, a CD-ROM, or any other form of storage medium known in the art. An exemplary storage medium is coupled to the processor such the processor may read information from, and write information to, the storage medium. In the alternative, the storage medium may be integral to the processor. In other words, the processor and the storage medium may reside in an integrated circuit or be implemented as discrete components.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory [EEPROM]), and/or any suitable combination thereof. The term “machine-readable medium” should be taken to include a single medium or multiple media (e.g., a centralized or distributed database, or associated caches and servers) able to store processor instructions. The term “machine-readable medium” shall also be taken to include any medium, or combination of multiple media, that is capable of storing instructions for execution by one or more processors, such that the instructions, when executed by one or more processors cause the one or more processors to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” as used herein excludes signals per se.

### Various Notes & Examples

Example 1 is a method of aggregating information in a data interchange system to be accessed by an entity, the data interchange system for use with a calendaring system for matters having due dates, comprises: identifying a matter to be updated by filtering a plurality of matters, the matter associated with at least one entity matter dataset; a first entity corresponding with a first entity matter dataset; the first entity granting a second, third, or more entity a privilege to access a second, third, or more entity matter dataset, the second, third, or more entity matter dataset corresponding with the second, third, or more entity; receiving an indication of a document having a due date and attributes, the document being sourced by the second, third, or more entity, and designated by a source category; transforming the document and the attributes of the document according to preferences as indicated by the second, third, or more entity to create a transformed transaction, the transformed transaction comprising the document, source category, and document attributes; logging the transformed transaction in the first, second, third, or more datasets, the second, third, or more datasets containing documents from the first entity matter dataset transformed according to the preferences of the second, third, or more entity; and communicating the transformed transaction to parties as indicated by a second, third, or more entity with communicating privileges.

In Example 2 the subject matter of Example 1 optionally includes wherein transforming the document and the attributes of the document according to preferences as indicated by the second, third, or more entity includes formatting updates, translation, terminology edits, updating of filing numbers, detecting of errors in deadlines, or other formatting nuances that have been indicated by the second, third, or more entity.

In Example 3 the subject matter of any one or more of Examples 1-2 optionally includes wherein the privilege to access the associated second, third, or more matter datasets includes at least one of owning, viewing, editing, deleting, exporting, and communicating documents stored within their matter dataset, and wherein privileges are revokable or reassignable by the first entity.

In Example 4 the subject matter of any one or more of Examples 1-3 optionally includes wherein filtering a plurality of matters further comprises receiving an indication of at least one of a country in which a patent application has been filed, application number, docket number, or an existing matter number.

In Example 5 the subject matter of any one or more of Examples 1-4 optionally includes wherein the document attributes include at least one of a filing date, communication date, status, patent number, country, or bibliographic information.

In Example 6 the subject matter of any one or more of Examples 1-5 optionally includes wherein an entity matter dataset is a collection of documents and information associated with a matter and is managed by the entity with ownership privileges.

In Example 7 the subject matter of any one or more of Examples 1-6 optionally includes wherein the source category is a document filed in a patent office, a document received from a patent office, or a validation.

In Example 8 the subject matter of any one or more of Examples 1-7 optionally includes wherein logging the transformed transaction in the second, third, or more entity matter dataset includes preserving history of the entity matter dataset.

In Example 9 the subject matter of any one or more of Examples 1-8 optionally includes wherein the privilege of owning enables the first entity to grant privileges to additional entities, delete documents, identify preferences, and identify third parties to receive transaction communications.

In Example 10 the subject matter of any one or more of Examples 1-9 optionally includes wherein the privilege of exporting enables the first entity to create an identical copy of a matter dataset to be pushed into an outside system owned by an entity with privilege to access the matter.

In Example 11 the subject matter of any one or more of Examples 1-10 optionally further comprises wherein the indication of the source category as a document filed in the patent office further comprises: receiving an indication from a user relating to a date that the document was filed in the patent office; downloading the document filed in the patent office; presenting a list to the user based on a data scrape of a database, wherein the database may be a governmental database; transmitting a request to the user, the request including a prompt to select a document from the list confirming it is the document being reported; and receiving a further designation by subcategory of the document to be reported in the source category of a document filed in the patent office.

In Example 12 the subject matter of any one or more of Examples 1-11 optionally includes wherein the document to be reported is an unpublished application in the source category of document filed in the patent office.

In Example 13 the subject matter of any one or more of Examples 1-12 optionally further comprises receiving an indication from the user relating to a date the unpublished application was filed in the patent office; and downloading one or more unpublished application documents, wherein the one or more unpublished application documents includes a reporting letter, request for grant of patent, acknowledgement of filing receipt, description, claims, drawings, abstract, or designation of inventor.

In Example 14 the subject matter of any one or more of Examples 1-13 optionally further comprises wherein the indication of the source category as a document received from a patent office further comprises: receiving an indication from a user relating to the date on the document received from a patent office; downloading the document received from the patent office; presenting a list to the user based on a data scrape of a database, wherein the database may be a governmental database; transmitting a request to the user, the request including a prompt to select a document from the list confirming it is the document being reported; and receiving a further designation by subcategory of the document to be reported in the source category of a document received from a patent office.

In Example 15 the subject matter of any one or more of Examples 1-14 optionally includes wherein the document to be reported is an unpublished application in the source category of a document received from the patent office.

In Example 16 the subject matter of any one or more of Examples 1-15 optionally further comprises receiving an indication from the user to input a date the unpublished application was received from the patent office; and downloading one or more unpublished application documents, wherein the one or more unpublished application documents include a reporting letter, communication regarding search, and notification of forthcoming publication.

In Example 17 the subject matter of any one or more of Examples 1-16 optionally includes wherein the indication of the source category of a validation further comprises: downloading a validation document from a user, wherein the validation document being downloaded is further designated by a subcategory including at least one of a reporting letter or national patent office information; and receiving an indication from the user regarding a status of the validation, wherein the status of the validation indicates either a new patent number or a completion of validation in one or more countries.

In Example 18 the subject matter of any one or more of Examples 1-17 optionally includes wherein receiving an indication from the user that the status of the validation is a new patent number further comprises: receiving a selection of a country from the user; presenting a field to allow the user to enter a new patent number; and forwarding the new patent number to a docketing department.

In Example 19 the subject matter of any one or more of Examples 1-18 optionally includes wherein receiving an indication from the user that the status of the validation is a completion of validation in one or more countries further comprises: receiving a selection of a country from the user; and generating a message to a docketing department to confirm completion of validation for those one or more countries.

Example 20 is at least one non-transitory machine-readable medium comprising instructions that, when executed by at least one processor implements a method of aggregating information in a data interchange system to be accessed by an entity, comprising: identifying a matter to be updated by filtering a plurality of matters, the matter associated with at least one entity matter dataset; a first entity corresponding with a first entity matter dataset; the first entity granting a second, third, or more entity a privilege to access a second, third, or more entity matter dataset, the second, third, or more entity matter dataset corresponding with the second, third, or more entity; receiving an indication of a document having a due date and attributes, the document being sourced by the second, third, or more entity, and designated by a source category; transforming the document and the attributes of the document according to preferences as indicated by the second, third, or more entity to create a transformed transaction, the transformed transaction comprising the document, source category, and document attributes; logging the transformed transaction in the first, second, third, or more datasets, the second, third, or more datasets containing documents from the first entity matter dataset transformed according to the preferences of the second, third, or more entity; and communicating the transformed transaction to parties as indicated by a second, third, or more entity with communicating privileges.

The above detailed description includes references to the accompanying drawings, which form a part of the detailed description. The drawings show, by way of illustration, specific embodiments in which the invention may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more”. In this document, the term “or” is used to refer to a nonexclusive or, such that “A or B” includes “A but not B”, “B but not A”, and “A and B”, unless otherwise indicated. In this document, the terms “including” and “in which” are used as the plain-English equivalents of the respective terms “comprising” and “wherein”. Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first”, “second”, and “third”, etc. are used merely as labels, and are not intended to impose numerical requirements on their objects.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is provided to comply with 37 C.F.R. § 1.72 (b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments may be combined with each other in various combinations or permutations. The scope of the invention should be determined with reference to the appended claims, along with the full scope of equivalents to which such claims are entitled.

What is claimed is:

1. A method of aggregating information in a data interchange system to be accessed by an entity, the data interchange system for use with a calendaring system for matters having due dates, wherein the method comprises:
identifying a matter to be updated by filtering a plurality of matters, the matter associated with at least one entity matter dataset; a first entity corresponding with a first entity matter dataset;
the first entity granting a second, third, or more entity a privilege to access a second, third, or more entity matter dataset, the second, third, or more entity matter dataset corresponding with the second, third, or more entity;
receiving an indication of a document having a due date and attributes, the document being sourced by the second, third, or more entity, and designated by a source category;
transforming the document and the attributes of the document according to preferences as indicated by the second, third, or more entity to create a transformed transaction, the transformed transaction comprising the document, source category, and document attributes;
logging the transformed transaction in the first, second, third, or more datasets, the second, third, or more datasets containing documents from the first entity matter dataset transformed according to the preferences of the second, third, or more entity; and
communicating the transformed transaction to parties as indicated by a second, third, or more entity with communicating privileges.

2. The method of claim 1, wherein transforming the document and the attributes of the document according to preferences as indicated by the second, third, or more entity includes formatting updates, translation, terminology edits, updating of filing numbers, detecting of errors in deadlines, or other formatting nuances that have been indicated by the second, third, or more entity.

3. The method of claim 1, wherein the privilege to access the associated second, third, or more matter datasets includes at least one of owning, viewing, editing, deleting, exporting, and communicating documents stored within their matter dataset, and wherein privileges are revokable or reassignable by the first entity.

4. The method of claim 1, wherein filtering a plurality of matters further comprises receiving an indication of at least one of a country in which a patent application has been filed, application number, docket number, or an existing matter number.

5. The method of claim 1, wherein the document attributes include at least one of a filing date, communication date, status, patent number, country, or bibliographic information.

6. The method of claim 1, wherein an entity matter dataset is a collection of documents and information associated with a matter and is managed by the entity with ownership privileges.

7. The method of claim 1 wherein the source category is a document filed in a patent office, a document received from a patent office, or a validation.

8. The method of claim 1 wherein logging the transformed transaction in the second, third, or more entity matter dataset includes preserving history of the entity matter dataset.

9. The method of claim 2, wherein the privilege of owning enables the first entity to grant privileges to additional entities, delete documents, identify preferences, and identify third parties to receive transaction communications.

10. The method of claim 2, wherein the privilege of exporting enables the first entity to create an identical copy of a matter dataset to be pushed into an outside system owned by an entity with privilege to access the matter.

11. The method of claim 7, wherein the indication of the source category as a document filed in the patent office further comprises:
receiving an indication from a user relating to a date that the document was filed in the patent office;
downloading the document filed in the patent office;
presenting a list to the user based on a data scrape of a database, wherein the database may be a governmental database;
transmitting a request to the user, the request including a prompt to select a document from the list confirming it is the document being reported; and
receiving a further designation by subcategory of the document to be reported in the source category of a document filed in the patent office.

12. The method of claim 11, wherein the document to be reported is an unpublished application in the source category of document filed in the patent office.

13. The method of claim 12, further comprising:
receiving an indication from the user relating to a date the unpublished application was filed in the patent office; and
downloading one or more unpublished application documents,
wherein the one or more unpublished application documents includes a reporting letter, request for grant of patent, acknowledgement of filing receipt, description, claims, drawings, abstract, or designation of inventor.

14. The method of claim 7, wherein the indication of the source category as a document received from a patent office further comprises:
receiving an indication from a user relating to the date on the document received from a patent office;
downloading the document received from the patent office;
presenting a list to the user based on a data scrape of a database, wherein the database may be a governmental database;
transmitting a request to the user, the request including a prompt to select a document from the list confirming it is the document being reported; and
receiving a further designation by subcategory of the document to be reported in the source category of a document received from a patent office.

15. The method of claim 14, wherein the document to be reported is an unpublished application in the source category of a document received from the patent office.

16. The method of claim 15, further comprising:
receiving an indication from the user to input a date the unpublished application was received from the patent office; and
downloading one or more unpublished application documents,
wherein the one or more unpublished application documents include a reporting letter, communication regarding search, and notification of forthcoming publication.

17. The method of claim 7, wherein the indication of the source category of a validation further comprises:
downloading a validation document from a user, wherein the validation document being downloaded is further designated by a subcategory including at least one of a reporting letter or national patent office information; and
receiving an indication from the user regarding a status of the validation, wherein the status of the validation indicates either a new patent number or a completion of validation in one or more countries.

18. The method of claim 17, wherein receiving an indication from the user that the status of the validation is a new patent number further comprises:
receiving a selection of a country from the user;
presenting a field to allow the user to enter a new patent number; and
forwarding the new patent number to a docketing department.

19. The method of claim 17, wherein receiving an indication from the user that the status of the validation is a completion of validation in one or more countries further comprises:
receiving a selection of a country from the user; and
generating a message to a docketing department to confirm completion of validation for those one or more countries.

20. At least one non-transitory machine-readable medium comprising instructions that, when executed by at least one processor implements a method of aggregating information in a data interchange system to be accessed by an entity, comprising:
identifying a matter to be updated by filtering a plurality of matters, the matter associated with at least one entity matter dataset; a first entity corresponding with a first entity matter dataset;
the first entity granting a second, third, or more entity a privilege to access a second, third, or more entity matter dataset, the second, third, or more entity matter dataset corresponding with the second, third, or more entity;
receiving an indication of a document having a due date and attributes, the document being sourced by the second, third, or more entity, and designated by a source category;
transforming the document and the attributes of the document according to preferences as indicated by the second, third, or more entity to create a transformed transaction, the transformed transaction comprising the document, source category, and document attributes;
logging the transformed transaction in the first, second, third, or more datasets, the second, third, or more datasets containing documents from the first entity matter dataset transformed according to the preferences of the second, third, or more entity; and
communicating the transformed transaction to parties as indicated by a second, third, or more entity with communicating privileges.
